(19) United States
(12) Patent Application Publication
(10) Pub. No.: US 2025/0060968 A1
(43) Pub. Date: Feb. 20, 2025

(54) MULTI-LEVEL HYBRID ALGORITHM FILTERING-TYPE BRANCH PREDICTION METHOD AND PREDICTION SYSTEM

(71) Applicant: Suzhou Ricore IC Technologies Ltd., Suzhou (CN)

(72) Inventors: Ran ZHANG, Suzhou (CN); Fei WANG, Suzhou (CN); Dongrui FAN, Suzhou (CN)

(21) Appl. No.: 18/684,962

(22) PCT Filed: Aug. 12, 2022
(86) PCT No.: PCT/CN2022/112073

§ 371 Date: Feb. 20, 2024

(30) Foreign Application Priority Data
May 10, 2022 (CN) 202210508788.1

(51) Int. Cl. G06F 9/38

(52) U.S. Cl. CPC G06F 9/3848; G06F 9/3806

(57) ABSTRACT

A multi-level hybrid algorithm filtering-type branch prediction method and prediction system includes: S1, arranging a first-stage branch target prediction table and a second-stage branch target prediction table; S2, any branch instruction accessing the first-stage branch target prediction table, determining whether the first-stage branch target prediction table hits, and if the first-stage branch target prediction table hits, then entering S3, and if the first-stage branch target prediction table does not hit, then entering S4; S3, determining whether a branch instruction of a current prediction is filtered out by the first-stage branch target prediction table, and if the branch instruction is filtered out, then entering S4, otherwise, then taking a prediction result provided by the first-stage branch target prediction table as a prediction address of the corresponding branch instruction; S4, accessing the second-stage branch target prediction table, and taking a prediction result provided by the second-stage branch target prediction table as a prediction address of the corresponding branch instruction.

### TECHNICAL FIELD

The present disclosure relates to the technical field of computer systems, in particular to a multi-level hybrid algorithm filter branch prediction method and prediction system.

### BACKGROUND

Modern processors generally use a branch prediction technology to predict the direction and target address of a branch before a branch instruction is executed. If the prediction is a jump, the instruction is fetched in advance according to the predicted address to prevent pipeline bubbles generated when the branch occurs from affecting performance. The principle of branch prediction is to save history information of branch instructions. When the same branch instruction is encountered again, the behavior of the branch instruction this time is predicted according to the saved history information.

The impact of branch instructions on performance mainly comes from two parts: the first part of impact comes from the time consumed in branch prediction, that is, the time consumed in accessing and arbitrating a prediction table, because the processor cannot obtain the subsequent instruction address before obtaining the prediction result, generally speaking, according to branch prediction algorithms with different complexities, one to three pipeline bubbles may be introduced in the first part of the impact; and the second part of the impact comes from the errors in predicting the direction or address of the branch performed by a predictor, which means that the pipeline will be executed on a path until an execution result of the branch instruction is obtained. The performance impact of branch prediction is mainly determined by the pipeline depth. Generally speaking, modern high-performance superscalar processors will introduce ten to twenty pipeline bubbles when encountering branch prediction errors.

Therefore, when designing a branch predictor, the above two parts of the impact need to be weighed. In order to improve the branch prediction accuracy, more complex branch prediction algorithms are usually used, which will inevitably increase the time required for branch prediction (that is, the first part of the impact of the aforementioned branch instructions on performance), and will also increase the power consumption and area of the branch predictor. Therefore, a traditional predictor usually adopts a more compromised method to control the branch prediction time within two bubbles to achieve acceptable prediction accuracy. However, this method uses the same prediction for different branches, without considering the differences between various branches.

FIG. 1 is a schematic diagram of a branch prediction pipeline in the prior art. As shown in FIG. 1, predictors are divided into a first level of predictor and a second level of predictor, and early branch prediction is performed by the smaller first level of predictor to reduce the prediction time, and later branch prediction is performed by the larger second level of predictor to improve prediction accuracy. However, the prediction method shown in FIG. 1 does not distinguish the difficulty of branch prediction, so two prediction tables in the two levels of predictors need to predict all branches at the same time. Therefore, the power consumption of the predictor still cannot be reduced.

### SUMMARY

In order to solve the above problems, the present disclosure provides a multi-level hybrid algorithm filter branch prediction method and prediction system. By using prediction algorithms of two complexities, for a branch that is relatively “easy” to predict, the first level, that is, the lower complexity of predictor implemented by a prediction algorithm is used to predict the branch. Since the first level of algorithm is simple, a prediction result may be obtained quickly (one pipeline bubble). Since the branch instruction is “easy” to predict, sufficiently high prediction accuracy may also be achieved. Meanwhile, the first level of predictor needs to filter out branch instructions that are “not easy” to predict. For instructions that are “not easy” to predict, the second level that is, the higher complexity of predictor is turned on to predict the branch. Two pipeline bubbles need to be introduced in the prediction time of the L2 instructions, but since such instructions are filtered, the number of such instructions is very small, so the impact on processor performance is very small. Therefore, the present disclosure can better balance the prediction time and accuracy, and due to the introduction of a filtering mechanism, more targeted predictions can be made by the two predictors, thereby improving the accuracy and resource usage rate, and effectively reducing the power consumption of the processor.

In order to achieve the above object, the present disclosure provides a multi-level hybrid algorithm filter branch prediction method, including:
Step S1: setting two-level branch target prediction tables, including: a level 1 branch target prediction table (L1BTPT) and a level 2 branch target prediction table (L2BTPT);
Step S2: accessing the L1BTPT by any branch instruction, and judging whether the L1BTPT is hit,
if the L1BTPT is hit, proceeding to step S3; and
if the L1BTPT is missed, proceeding to step S4;
Step S3: judging whether a currently predicted branch instruction is filtered out by the L1BTPT, if so, proceeding to step S4; otherwise, taking a prediction result provided by the L1BTPT as a predicted address of a corresponding branch instruction; and
Step S4: accessing the L2BTPT, and taking a prediction result provided by the L2BTPT as a predicted address of a corresponding branch instruction.

In an embodiment of the present disclosure, step S2 further includes:
setting an index in the L1BTPT, and configuring the index to match an address of a branch instruction;
providing credibility predictions in the L1BTPT for prediction difficulty filtering; and
adopting PLRU replacement policies in the L1BTPT to retain history records of recently executed branch instructions.

In an embodiment of the present disclosure, a data structure of the L1BTPT includes 16 entries, including: Entry0-Entry 15, and each entry includes FullTag, predTarget, Conf, Vld and PLRU, wherein:
FullTag is a part configured for address matching, the index of the L1BTPT matches the high bits of the address of the branch instruction with the FullTag, if the high bits of the address of the branch instruction are equal to the FullTag, it is determined that the L1BTPT is hit;
predTarget is a part that records a jump address before the corresponding branch instruction, and is configured to provide a predicted address of the corresponding branch instruction;
Conf is a part that provides the credibility of a prediction, an initial value of the Conf is a two-digit binary expression 10, if the prediction is wrong, then the Conf becomes Conf−1, and if the prediction is correct, then the Conf becomes Conf+1;
Vld is an identification part configured to identify whether the prediction is valid; and
PLRU is a part that identifies each replacement policy, and PLRU is a four-digit binary expression configured to identify the replacement order of the 16 entries.

In an embodiment of the present disclosure, the PLRU replacement policy is: when a new L1BTPT entry needs to be established, a Least Recently Used (LRU) entry is first replaced, and an age order of the 16 entries is identified by a four-digit binary expression PLRU[3:0], wherein:
PLRU[0] is adopted to identify a piece of information of a node L1, if PLRU[0]==1, then the entry identifying the LRU is in Entry{0,1,2,3,4,5,6,7};
PLRU[1] is adopted to identify a piece of information of a node L2, if PLRU[1]==1, then the entry identifying the LRU is in Entry{0,1,2,3,8,9,10,11};
PLRU[2] is adopted to identify a piece of information of a node L3, if PLRU[2]==1, then the entry identifying the LRU is in Entry{0,1,4,5,8,9,12,13}; and
PLRU[3] is adopted to identify a piece of information of a node L4, if PLRU[3]==1, then the entry identifying the LRU is in Entry{0,2,4,6,8,10,12,14}.

In an embodiment of the present disclosure, a data structure of the L2BTPT includes:
a Path History Register (PHR);
at least two Tag History Tables (THT), including: a THT0 and a THT1, wherein the THT0 and the THT1 correspond to the PHR respectively, and a bit length of PHR corresponding to the THT1 is greater than a bit length of PHR corresponding to the THT0;
the L2BTPT selects a final prediction result based on the hit status of the THT0 and the THT1 and updates the PHR, wherein:
if both the THT0 and the THT1 are not hit, it is determined that the L2BTPT is missed, and no prediction result is provided;
if the THT0 is hit but the THT1 is missed, it is determined that the L2BTPT is hit, and the prediction result is selected from the THT0; and
if the THT1 is hit, it is determined that the L2BTPT is hit, and the prediction result is selected from the THT1.

In an embodiment of the present disclosure, the PHR is a 48-bit binary expression, marked as PHR[47:0], and each THT includes 64 entries and a two-way set associated mapping structure.

In an embodiment of the present disclosure, a specific hit judgment method of the THT0 and the THT1 comprises:
marking the first 18-bit binary expression of the PHR as PHR[17:0] and taking the expression PHR[17:0] as an index of the THT0, performing a hash calculation on a branch address of a corresponding branch instruction and the PHR[17:0] so as to obtain a hash calculation result, finding a corresponding entry, comparing a Tag value in the hash calculation result with a Tag value in the found entry, and if the Tag value in the hash calculation result is equal to the Tag value in the found entry, determining that the THT0 is hit; and
taking PHR [47:0] as an index of the THT1, performing a hash calculation on a branch address of a corresponding branch instruction and the PHR[47:0] so as to obtain a hash calculation result, finding a corresponding entry, comparing a Tag value in the hash calculation result with a Tag value in the found entry, and if the Tag value in the hash calculation result is equal to the Tag value in the found entry, determining that the THT1 is hit.

In an embodiment of the present disclosure, the process of updating the PHR comprises: performing a hash calculation on the address of the corresponding branch instruction and the target address of the branch, intercepting last n bits, and pressing the last n bits into the PHR.

In order to achieve the above object, the present disclosure further provides a multi-level hybrid algorithm filter branch prediction system configured to implement the above method, which includes:
an L1BTPT, set in an L1 pipeline and connected to an IP multiplexer;
a branch target prediction table controller, set in an L2 pipeline and connected to the L1BTPT for filtering control; and
an L2BTPT, set in an L3 pipeline and connected to the IP multiplexer and the branch target prediction table controller respectively;
wherein an output of the L1BTPT and an output of the L2BTPT are connected to the IP multiplexer for returning prediction results.

Compared with the prior art, the multi-level hybrid algorithm filter branch prediction method and prediction system disclosed in the present disclosure have at least the following advantages:
1) When a certain branch hits the L1 prediction table, the predicted address may be obtained quickly. At this time, the L2 prediction table is not enabled. Since the L2 prediction table is not enabled, most power consumption may be reduced., and since the prediction time is short, pipeline execution may not be blocked for a long time; and
2) When the L1 prediction table is missed, or it is found that the target address of a certain branch changes (is not easy to predict) according to global history information, it is necessary to access the L2 prediction table, which can not only ensure prediction accuracy, but also shorten prediction time and reduce power consumption.

### BRIEF DESCRIPTION OF THE DRAWINGS

In order to explain the technical solutions in the embodiments of the present disclosure or the prior art more clearly, the drawings to be used in the description of the embodiments or the prior art will be briefly introduced below. Obviously, the drawings in the following description are only some embodiments of the present disclosure. For those having ordinary skill in the art, other drawings may be obtained based on these drawings without creative effort.

FIG. 1 is a schematic diagram of a branch prediction pipeline in the prior art;

FIG. 2 is a flow chart of a method according to an embodiment of the present disclosure;

FIG. 3 shows a data structure of a level 1 branch target prediction table according to an embodiment of the present disclosure;

FIG. 4 is a schematic diagram of various replacement policies in the level 1 branch target prediction table according to an embodiment of the present disclosure;

FIG. 5 shows a data structure of a level 2 branch target prediction table according to an embodiment of the present disclosure; and

FIG. 6 is a structure diagram of a system according to an embodiment of the present disclosure.

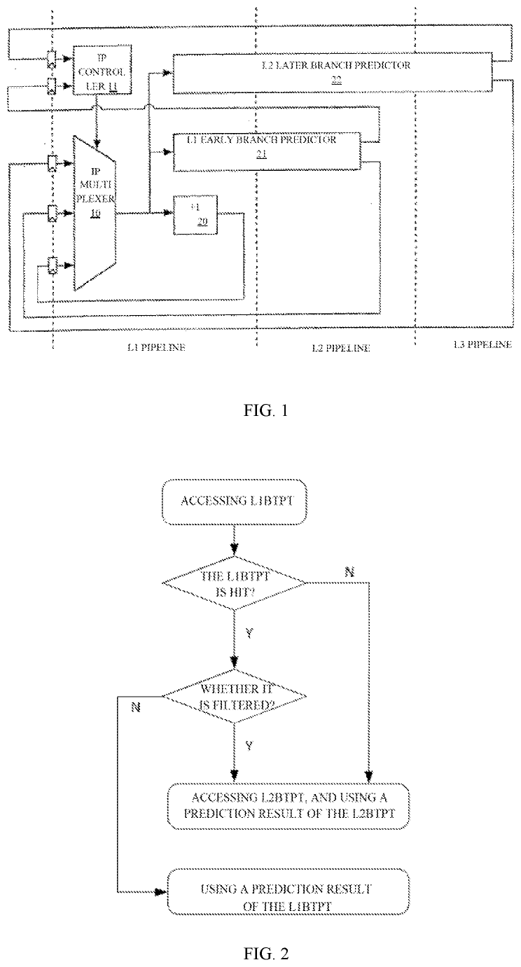

Reference numerals: L1BTPT, 101—level 1 branch target prediction table; L2BTPT, 103—level 2 branch target prediction table; 102—branch target prediction table controller; 104—IP multiplexer.

### DETAILED DESCRIPTION

The technical solutions in the embodiments of the present disclosure will be clearly and completely described below with reference to the accompanying drawings in the embodiments of the present disclosure. Obviously, the described embodiments are only some of, not all of, the embodiments of the present disclosure. All other embodiments obtained by those having ordinary skill in the art based on the embodiments of the present disclosure without creative effort shall fall within the scope of protection of the present disclosure.

FIG. 2 is a flow chart of a method according to an embodiment of the present disclosure. As shown in FIG. 2, this embodiment provides a multi-level hybrid algorithm filter branch prediction method, which includes:

In a step of S1, two-level branch target prediction tables (hereinafter referred to as BTPT) are set, including: a level 1 branch target prediction table (L1BTPT) and a level 2 branch target prediction table (L2BTPT).

In a step of S2, the L1BTPT is accessed by any branch instruction, and it is judged whether the L1BTPT is hit,
if the L1BTPT is hit, proceeding to step S3; and
if the L1BTPT is missed (that is, if the L1BTPT is not hit), proceeding to step S4.

In a step S3, it is judged whether a currently predicted branch instruction is filtered out by the L1BTPT, if so, proceeding to step S4; otherwise, a prediction result provided by the L1BTPT is taken as a predicted address of a corresponding branch instruction.

In a step S4, the L2BTPT is accessed, and a prediction result provided by the L2BTPT is taken as a predicted address of a corresponding branch instruction.

In this embodiment, step S2 further includes:
An index is set in the L1BTPT, and the index is configured to match an address of a branch instruction;
Credibility predictions are provided in the L1BTPT for prediction difficulty filtering; and
Pseudo Least Recently Used (PLRU) replacement policies (also called pseudo LRU policies) are adopted in the L1BTPT to retain history records of recently executed branch instructions.

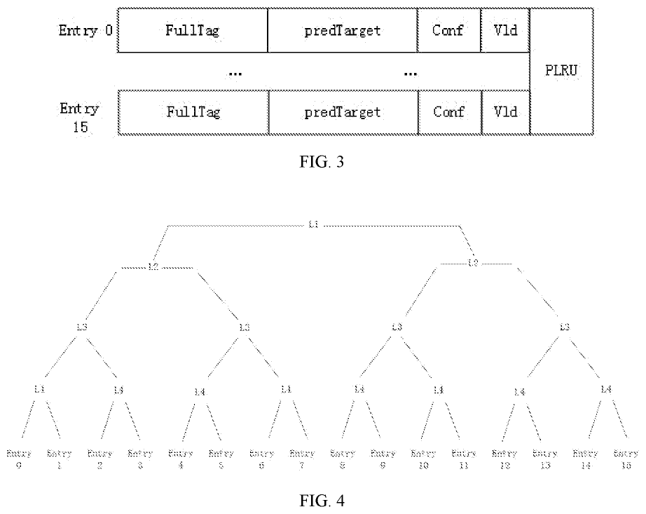

FIG. 3 shows a data structure of an L1BTPT according to an embodiment of the present disclosure. As shown in FIG. 3, in this embodiment, the data structure of the L1BTPT includes 16 entries, including: Entry0-Entry 15, and each entry includes FullTag, predTarget, Conf, Vld and PLRU, wherein:
FullTag is a part configured for address matching, the index of the L1BTPT matches the high bits of the address of the branch instruction with the FullTag, if the high bits of the address of the branch instruction are equal to the FullTag, it is determined that the LL1BTPT is hit;
predTarget is a part that records a jump address before the corresponding branch instruction, and is configured to provide a predicted address of the corresponding branch instruction;
Conf is a part that provides the credibility of a prediction, an initial value of the Conf is a two-bit binary expression (2-bit) 10, if this prediction is wrong, then the Conf becomes Conf−1, and if this prediction is correct, then the Conf becomes Conf+1; for example, if the first prediction is correct, the Conf becomes 11, reaching the maximum value, and if the next prediction is also correct, the Conf continues to be 11; and if the first prediction is wrong, the Conf becomes 01, and if the next prediction is also wrong, the Conf becomes 00, reaching the minimum value;
Vld is an identification part configured to identify whether the prediction is valid; and PLRU is a part that identifies each replacement policy, and PLRU is a four-bit binary expression (4-bit) configured to identify the replacement order of the 16 entries.

FIG. 4 is a schematic diagram of various replacement policies in the L1BTPT according to an embodiment of the present disclosure. As shown in FIG. 4, in this embodiment, the PLRU replacement policy is: when a new L1BTPT Entry needs to be established, a Least Recently Used (LRU) entry is first replaced by adopting an algorithm which is a PLRU algorithm, and an age order of the 16 entries (Entry0-Entry 15) is identified by a four-bit binary expression (4-bit) PLRU[3:0] of, wherein:
PLRU[0] is adopted to identify a piece of information of a node L1, if PLRU[0]==1, then the entry identifying the LRU is in Entry {0,1,2,3,4,5,6,7};
PLRU[1] is adopted to identify a piece of information of a node L2, if PLRU[1]==1, then the entry identifying the LRU is in Entry {0,1,2,3,8,9,10,11};
PLRU[2] is adopted to identify a piece of information of a node L3, if PLRU[2]==1, then the entry identifying the LRU is in Entry {0, 1,4,5,8,9,12,13}; and
PLRU[3] is adopted to identify a piece of information of a node L4, if PLRU[3]==1, then the entry identifying the LRU is in Entry {0,2,4,6,8,10,12,14}.

In other embodiments, the number of entries included in the data structure of the L1BTPT may also be other value, which is not limited to 16 in the present disclosure. In addition, the Conf is not limited to a two-bit binary expression (2-bit), and more bits may be used. The present disclosure provides prediction difficulty filtering. If L1BTPT fails to predict continuously, the Conf will drop to 0, which indicates that such branches require more complex prediction algorithms (prediction mechanisms that rely on branch history information) to enable access to the L2BTPT. PLRU is not limited to four-bit binary expression (4-bit). The present disclosure retains history records of recently executed branch instructions by the PLRU replacement policies to achieve the purpose of improving usage efficiency.

The L1BTPT may be established and updated based on a TAGE algorithm, which will not be limited in the present disclosure.

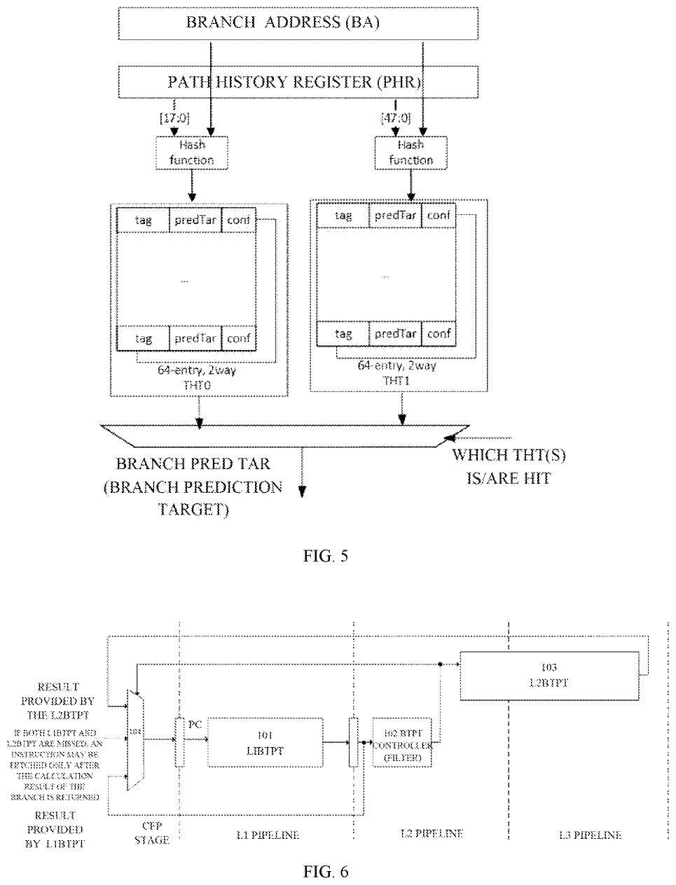

FIG. 5 shows a data structure of the L2BTPT according to an embodiment of the present disclosure. As shown in FIG. 5, in this embodiment, the data structure of the L2BTPT includes:
a Path History Register (PHR);
at least two Tag History Tables (THT), including: a THT0 and a THT1, wherein the THT0 and the THT1 correspond to the PHR respectively, and a bit length of PHR corresponding to the THT1 is greater than a bit length of PHR corresponding to the THT0;
the L2BTPT selects a final prediction result based on the hit status of the THT0 and the THT1 and updates the PHR, wherein:
if both the THT0 and the THT1 are not hit, it is determined that the L2BTPT is missed, and no prediction result is provided;
if the THT0 is hit but the THT1 is missed, it is determined that the L2BTPT is hit, and the prediction result is selected from the THT0; and
if the THT1 is hit, it is determined that the L2BTPT is hit, and the prediction result is selected from the THT1.

In this embodiment, the PHR is a 48-bit binary expression (48-bit), marked as PHR[47:0] (that is, a total of 48-bits from bit 0 to bit 47), and each THT includes 64 entries (64-Entry) and a two-way set associated mapping structure (2-Way).

In this embodiment, a specific hit judgment method of the THT0 and the THT1 comprises:
marking the first 18-bit binary expression (18-bit) of the PHR as PHR[17:0] (that is, a total of 18-bits from bit 0 to bit 17) and taking the expression PHR[17:0] as an index of the THT0, performing a hash calculation on the branch address (BA) of the corresponding branch instruction and the PHR[17:0] so as to obtain a hash calculation result, finding a corresponding entry, comparing a Tag value in the hash calculation result with a Tag value in the found entry, and if the Tag value in the hash calculation result is equal to the Tag value in the found entry, determining that the THT0 is hit; and
taking PHR[47:0] as an index of the THT1, performing a hash calculation on the branch address (BA) of the corresponding branch instruction and the PHR[47:0] so as to obtain a hash calculation result, finding a corresponding entry, comparing a Tag value in the hash calculation result with a Tag value in the found entry, if the Tag value in the hash calculation result is equal to the Tag value in the found entry, determining that the THT1 is hit.

In this embodiment, the process of updating the PHR comprises: performing a hash calculation on the address of the corresponding branch instruction and the target address of the branch, intercepting last n bits (n-bits), and pressing the last n bits (n-bits) into the PHR, wherein n in this embodiment is 4, that is, the last 4-bits are pressed into the PHR.

Although the length of the PHR is 48-bit in this embodiment, it is not limited to 48-bit, and the number of the same THT entries is not limited to 2. The core of the L2BTPT algorithm of the present disclosure is: 1) the index of THTs needs to consider PHR, so the index will use the hash calculation result of the PHR and the branch address (BA); 2) according to the length of the PHR to which the branch prediction depends, more THTs may be used. After multiple THTs are hit, a THT with the longest PHR is selected; 3) the method of updating the PHR includes: performing a hash calculation on the address of the branch instruction and the target address of the branch, intercepting last n bits, and pressing the last n-bits into the PHR. Tag, predTar and Conf included in THT may be used in the same manner as the data table in the prior art, which will not be repeated here.

FIG. 6 is a structure diagram of a system according to an embodiment of the present disclosure. As shown in FIG. 6, this embodiment provides a multi-level hybrid algorithm filter branch prediction system configured to implement the above method, which includes:
an L1BTPT (101), set in an L1 pipeline and connected to an IP multiplexer (104);
a branch target prediction table controller (102), set in an L2 pipeline and connected to the L1BTPT (101) for filtering control; and
an L2BTPT (103), set in an L3 pipeline and connected to the IP multiplexer (104) and the branch target prediction table controller (102) respectively;
wherein an output of the L1BTPT (101) and an output of the L2BTPT (103) are connected to the IP multiplexer (104) for returning prediction results.

When a certain branch hits the L1BTPT, the predicted address may be obtained quickly. At this time, the L2BTPT is not enabled. Since the L2BTPT is not enabled, most power consumption may be reduced, and since the prediction time is short, the pipeline execution may not be blocked for a long time.

When the L1BTPT is missed, or it is found that the target address of a certain branch changes (is not easy to predict) according to global history information, it is necessary to access the L2BTPT, so that the prediction accuracy may not be reduced. The L2BTPT of the present disclosure may only be enabled when necessary, which can shorten the prediction time and power consumption on the premise of ensuring that the prediction rate is not reduced.

In the cfp stage (the target address of the branch has been calculated) in FIG. 6, if the L1BTPT is missed and L1BTPT is not filtered out (filter miss), and the L2BTPT is missed and the branch is a BTPT Eligible branch (indirect and non-linkstack operation branch), L1BTPT may be established;

In the stage after an L3 pipeline (regarded as an L4 pipeline), if the L1BTPT is missed and the L1BTPT is not filtered out (filter miss), and the L2BTPT is hit and the branch is a BTPT Eligible branch (indirect and non-linkstack operation branch), the L1BTPT may be established.

The multi-level hybrid algorithm filter branch prediction method and prediction system disclosed in the present disclosure have at least the following advantages:
1) When a certain branch hits the L1BTPT, the predicted address may be obtained quickly. At this time, the L2BTPT is not enabled. Since the L2BTPT is not enabled, most power consumption may be reduced, and since the prediction time is short, pipeline execution may not be blocked for a long time; and
2) When the L1BTPT is missed, or it is found that the target address of a certain branch changes (is not easy to predict) according to global history information, it is necessary to access the L2BTPT, which can not only ensure prediction accuracy, but also shorten prediction time and reduce power consumption.

Those having ordinary skill in the art can understand that the drawing is only a schematic diagram of an embodiment, and the modules or processes in the drawing are not necessarily necessary for implementing the present disclosure.

Those having ordinary skill in the art can understand that the modules in the device in the embodiment may be distributed in the device in the embodiment as described in the embodiment, or may be correspondingly changed and located in one or more devices different from that in this embodiment. The modules of the above embodiment may be combined into one module, or further divided into multiple sub-modules.

It should be noted finally that the above embodiments are only used for describing the technical solutions of the present disclosure rather than limiting the same. Although the present disclosure is described in detail with reference to the foregoing embodiments, those having ordinary skill in the art should understand that: the technical solutions recorded in the foregoing embodiments can be still amended, or some technical features therein can be replaced equivalently. However, these amendments or replacements do not cause the essence of the corresponding technical solutions to depart from the spirit and scope of the technical solutions of the embodiments of the present disclosure.

1. A multi-level hybrid algorithm filter branch prediction method, comprising:
Step S1: setting two-level branch target prediction tables, including: a level 1 branch target prediction table (L1BTPT) and a level 2 branch target prediction table (L2BTPT);
Step S2: accessing the L1BTPT by any branch instruction, and judging whether the L1BTPT is hit;
if the L1BTPT is hit, proceeding to step S3; and
if the L1BTPT is missed, proceeding to step S4;
Step S3: judging whether a currently predicted branch instruction is filtered out by the L1BTPT, if so, proceeding to step S4; otherwise, taking a prediction result provided by the L1BTPT as a predicted address of a corresponding branch instruction; and
Step S4: accessing the L2BTPT, and taking a prediction result provided by the L2BTPT as a predicted address of a corresponding branch instruction.

2. The branch prediction method of claim 1, wherein step S2 further comprises:
setting an index in the L1BTPT, and configuring the index to match an address of a branch instruction;
providing credibility predictions in the L1BTPT for prediction difficulty filtering; and
adopting Pseudo Least Recently Used (PLRU) replacement policies in the L1BTPT to retain history records of recently executed branch instructions.

3. The branch prediction method of claim 2, wherein a data structure of the L1BTPT comprises 16 entries, including: Entry0-Entry15, and each entry comprises FullTag, predTarget, Conf, Vld and PLRU, wherein:
FullTag is a part configured for address matching, the index of the L1BTPT matches the high bits of the address of the branch instruction with the FullTag; if the high bits of the address of the branch instruction are equal to the FullTag, it is determined that the L1BTPT is hit;
predTarget is a part that records a jump address before the corresponding branch instruction, and is configured to provide a predicted address of the corresponding branch instruction;
Conf is a part that provides the credibility of a prediction, an initial value of the Conf is a two-digit binary expression 10, if the prediction is wrong, then the Conf becomes Conf−1, and if the prediction is correct, then the Conf becomes Conf+1;
Vld an identification part configured to identify whether the prediction is valid; and
PLRU is a part that identifies each replacement policy, and PLRU is a four-digit binary expression configured to identify the replacement order of the 16 entries.

4. The branch prediction method of claim 3, wherein the PLRU replacement policy is: when a new L1BTPT entry needs to be established, a Least Recently Used (LRU) entry is first replaced, and an age order of the 16 entries is identified by a four-digit binary expression PLRU[3:0], wherein:
PLRU[0] is adopted to identify a piece of information of a node L1, if PLRU[0]==1, then the entry identifying the LRU is in Entry {0,1,2,3,4,5,6,7};
PLRU[1] is adopted to identify a piece of information of a node L2, if PLRU[1]==1, then the entry identifying the LRU is in Entry {0,1,2,3,8,9,10,11};
PLRU[2] is adopted to identify a piece of information of a node L3, if PLRU[2]==1, then the entry identifying the LRU is in Entry {0,1,4,5,8,9,12,13}; and
PLRU[3] is adopted to identify a piece of information of a node L4, if PLRU[3]==1, then the entry identifying the LRU is in Entry {0,2,4,6,8,10,12,14}.

5. The branch prediction method of claim 1, wherein a data structure of the L2BTPT comprises:
a Path History Register (PHR);
at least two Tag History Tables (THT), including: a THT0 and a THT1, wherein the THT0 and the THT1 correspond to the PHR respectively, and a bit length of PHR corresponding to the THT1 is greater than a bit length of PHR corresponding to the THT0;
the L2BTPT selects a final prediction result according to the hit status of the THT0 and the THT1 and updates the PHR, wherein:
if both the THT0 and the THT1 are not hit, it is determined that the L2BTPT is missed, and no prediction result is provided;
if the THT0 is hit but the THT1 is missed, it is determined that the L2BTPT is hit, and the prediction result is selected from the THT0; and
if the THT1 is hit, it is determined that the L2BTPT is hit, and the prediction result is selected from the THT1.

6. The branch prediction method of claim 5, wherein the PHR is a 48-bit binary expression, marked as PHR[47:0], and each THT comprises 64 entries and a two-way set associated mapping structure.

7. The branch prediction method of claim 6, wherein a hit judgment method of the THT0 and the THT1 comprises:
marking the first 18-bit binary expression of the PHR as PHR[17:0] and taking the expression PHR[17:0] as an index of the THT0, performing a hash calculation on a branch address of a corresponding branch instruction and the PHR[17:0] so as to obtain a hash calculation result, finding a corresponding entry, comparing a Tag value in the hash calculation result with a Tag value in the found entry, and if the Tag value in the hash calculation result is equal to the Tag value in the found entry, determining that the THT0 is hit; and
taking PHR[47:0] as an index of the THT1, performing a hash calculation on a branch address of a corresponding branch instruction and the PHR[47:0] so as to obtain a hash calculation result, finding a corresponding entry, comparing a Tag value in the hash calculation result with a Tag value in the found entry, and if the Tag value in the hash calculation result is equal to the Tag value in the found entry, determining that the THT1 is hit.

8. The branch prediction method of claim 7, wherein the process of updating the PHR comprises: performing a hash calculation on the address of the corresponding branch instruction and the target address of the branch, intercepting last n bits, and pressing the last n bits into the PHR.

9. A multi-level hybrid algorithm filter branch prediction system, configured to implement the method of claim 1, comprising:
an L1BTPT, set in a level 1 (L1) pipeline and connected to an IP multiplexer;
a branch target prediction table controller, set in a level 2 (L2) pipeline and connected to the L1BTPT for filtering control; and
an L2BTPT, set in a level 3 (L3) pipeline and connected to the IP multiplexer and the branch target prediction table controller respectively;
wherein an output of the L1BTPT and an output of the L2BTPT are connected to the IP multiplexer for returning prediction results.
